(19) United States
(12) Patent Application Publication
(10) Pub. No.: US 2019/0073702 A1
(43) Pub. Date: Mar. 7, 2019

(54) Systems And Methods For Reviewing And Selecting Hotels Based Upon Graded Parameters

(71) Applicant: Gautam Mukherjee, Toronto (CA)

(72) Inventor: Gautam Mukherjee, Toronto (CA)

(21) Appl. No.: 15/695,814

(22) Filed: Sep. 5, 2017

(51) Int. Cl. G06Q 30/02; G06F 17/30; G06Q 50/12

(52) U.S. Cl. CPC G06Q 30/0282; G06Q 10/02; G06Q 50/12; G06F 17/30867

(57) ABSTRACT

Disclosed is a method of reviewing and selecting hotels based upon graded parameters comprises storing hotel grades for each of a plurality of hotel parameters based upon reviews of past guest reviews; providing the plurality of hotel parameters to a client; receiving rankings of the client for the hotel parameter; ordering each ranked parameter from most important parameter to least important parameter; ordering hotels with the hotel grades for the most important parameter from highest graded hotel to lowest graded hotel; creating a list of hotels from highest graded hotel to lowest graded hotel; and, displaying the list of hotels to the client. If more than one of the hotels have the same hotel grade for the most important parameter, then the hotel with a higher rating for the next most important parameter is the higher graded hotel.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to software allows clients seeking a hotel room to review and select hotels based upon graded parameters. Generally, when a client is looking for a hotel room, the client may find hotels that are given a single rating and the client must read each review to determine the reasons why that reviewer rated the hotel. For example, the reviewer may have given a positive review for the hotel's service. Alternatively, the reviewer may have provided a negative review for the hotel's location. As a result, the client must read through numerous reviews to determine whether that hotel would be satisfactory to the client's specific set of needs. The present invention solves these and other problems by providing a novel method and system for reviewing and selecting a hotel. For example, the client may be focused on hotels with good service. The present invention allows the client to choose the good service as the most important criterion and the resulting search will provide a list of hotels with the highest grades for providing good service to its past patrons. Then, the second most important selected criterion will come into play and grade the set retrieved on the search for “Good service,” according to the second most important criterion, and so on, for other selected criteria.

### BRIEF SUMMARY OF THE INVENTION

An embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of reviewing and selecting hotels based upon graded parameters, the method comprising: storing hotel grades for each of a plurality of hotel parameters based upon reviews of past guest reviews; providing the plurality of hotel parameters to a client; receiving rankings of the client for the hotel parameters; ordering each ranked parameter from most important parameter to least important parameter; ordering hotels with the hotel grades for the most important parameter from highest graded hotel to lowest graded hotel; creating a list of hotels from highest graded hotel to lowest graded hotel; wherein if more than one of the hotels have the same hotel grade for the most important parameter, then the hotel with a higher rating for the next most important parameter is the higher graded hotel; and, displaying the list of hotels to the client.

Another embodiment of the present invention is a method of reviewing and selecting hotels based upon graded parameters, the method comprising: storing hotel grades for each of a plurality of hotel parameters based upon reviews of past guest reviews; providing the plurality of hotel parameters to a client; receiving rankings of the client for the hotel parameters; ordering each ranked parameter from most important parameter to least important parameter; ordering hotels with the hotel grades for the most important parameter from highest graded hotel to lowest graded hotel; creating a list of hotels from highest graded hotel to lowest graded hotel; wherein if more than one of the hotels have the same hotel grade for the most important parameter, then the hotel with a higher rating for the next most important parameter is the higher graded hotel; and, displaying the list of hotels to the client.

Yet another embodiment of the present invention is a non-transitory computer readable medium having computer readable instructions embodied therein, the computer readable instructions being configured to implement a method of reviewing and selecting hotels based upon graded parameters, the method comprising: storing hotel grades for each of a plurality of hotel parameters based upon reviews of past guest reviews; providing the plurality of hotel parameters to a client; receiving rankings of the client for the hotel parameters; ordering each ranked parameter from most important parameter to least important parameter; ordering hotels with the hotel grades for the most important parameter from highest graded hotel to lowest graded hotel; creating a list of hotels from highest graded hotel to lowest graded hotel; wherein if more than one of the hotels have the same hotel grade for the most important parameter, then the hotel with a higher rating for the next most important parameter is the higher graded hotel; and, displaying the list of hotels to the client.

In another embodiment of the present invention, the method further comprises: displaying the hotel grades of each parameter for a client-selected hotel from the list of hotels; and, displaying hotel information for the client-selected hotel.

In yet another embodiment of the present invention, wherein the method further comprises: receiving booking information from the client.

In another embodiment of the present invention, the method further comprises: obtaining client-inputted hotel grades for the client-selected hotel; obtaining a client-inputted written review for the client-selected hotel; calculating updated hotel grades for the hotel parameters; and, storing the updated hotel grades for the hotel parameters.

In yet another embodiment of the present invention, each of the parameters are selected from the group consisting of room feature, convenience of location, value for money, hotel characteristic, hotel service, amenity, and combinations thereof.

In yet another embodiment of the present invention, the room feature is selected from the group consisting of nicely furnished rooms, well appointed bathrooms, views, cleanliness of rooms, kitchen, refrigerator, microwave, and combinations thereof. The convenience of location is selected from the group consisting of restaurants nearby, distance from center of town, distance to airport, near public transportation, neighborhood safety, distance from attractions, ambience of hotel, environmental setting of the hotel, and combinations thereof. The hotel characteristic is selected from the group consisting of good service, eco-friendly, family-friendly, business-friendly, couple-friendly, pet-friendly, amenities for the disabled, and combinations thereof. The hotel service is selected from the group consisting of automated check-in, loyalty programs, and combinations thereof. The amenity is selected from the group consisting of gym, same day laundry, business center, pool, sauna, jacuzzi, on-site restaurant, internet, parking, breakfast included, and combinations thereof.

In another embodiment of the present invention, the parameters are nicely furnished rooms, good service, restaurants nearby, distance from center of town, value for money, good sized rooms, automated check-in, gym, same day laundry, and business center.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 illustrates an embodiment of a process of reviewing and selection hotels based upon graded parameters.

FIG. 2 illustrates a computerized system of an embodiment of the present invention.

FIG. 3 is an example of a computing environment that can be utilized by embodiments of the present invention.

FIG. 4 illustrates an example of a computing system that can be configured to perform any of the processes of the present invention described herein.

FIGS. 5-7 illustrate screen shots of a graphical user interface for implementation of embodiments of the present invention.

### DETAILED DESCRIPTION OF THE INVENTION

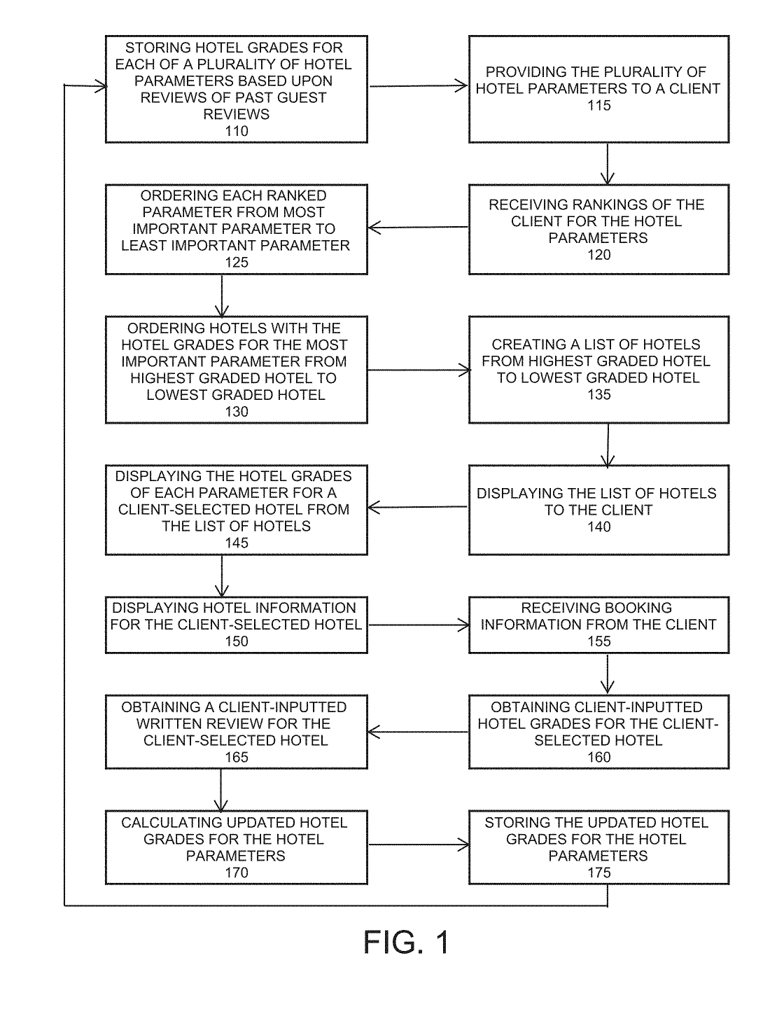

As illustrated in FIG. 1, an embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of reviewing and selecting hotels based upon graded parameters.

The method of reviewing and selecting hotels based upon graded parameters comprises storing hotel grades for each of a plurality of hotel parameters based upon reviews of past guest reviews 110; providing the plurality of hotel parameters to a client 115; receiving rankings of the client for the hotel parameters 120; ordering each ranked parameter from most important parameter to least important parameter 124; ordering hotels with the hotel grades for the most important parameter from highest graded hotel to lowest graded hotel 130; creating a list of hotels from highest graded hotel to lowest graded hotel 135; and, displaying the list of hotels to the client 140. If more than one of the hotels have the same hotel grade for the most important parameter, then the hotel with a higher rating for the next most important parameter is the higher graded hotel.

The method may further comprise: displaying the hotel grades of each parameter for a client-selected hotel from the list of hotels 145; and, displaying hotel information for the client-selected hotel 150. The hotel information may include the hotel's name, address, description, written reviews by past guests, ratings of each parameter, among other hotel information.

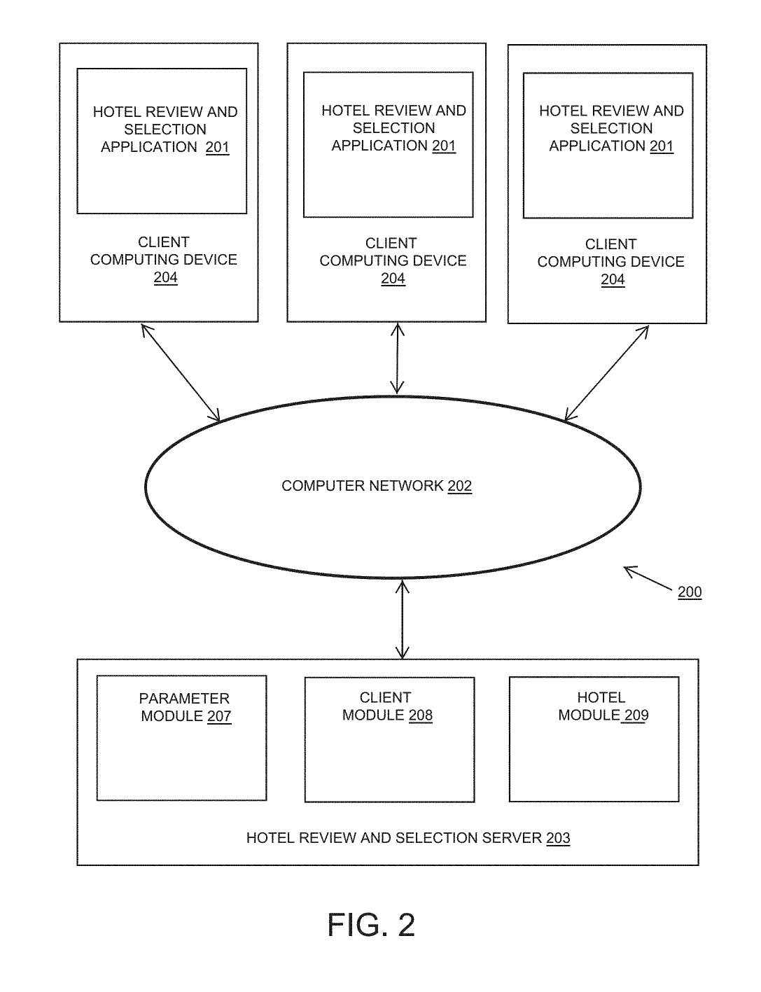

The method may further comprise: receiving booking information from the client 155. The booking information may include having the client register with hotel review and selection application 201 (see FIG. 2). The booking information may also include the client's name, screen name, email address, among other client information.

The method may further comprise: obtaining client-inputted hotel grades for the client-selected hotel 160; obtaining a client-inputted written review for the client-selected hotel 165; calculating updated hotel grades for the hotel parameters 170; and, storing the updated hotel grades for the hotel parameters 175. The client may optionally provide a written review of the hotel. By calculating 170 and storing the updated hotel grades for the hotel parameters 175, the hotel review and selection application 201 will have the current hotel parameter grades so the next client will have a better rating of the hotel.

Hotel parameters include room feature, convenience of location, value for money, hotel characteristic, hotel service, amenity, and combinations thereof. Value for money refers to reviewers' opinion about whether the hotel was worth the price they paid for the hotel.

Room features include parameters such as nicely furnished rooms, well appointed bathrooms, views, cleanliness of rooms, kitchen, refrigerator, microwave, and combinations thereof. Views may refer to whether the hotel affords pleasant scenery, such as a beach, ocean, lake, a landmark (e.g., the Eiffel Tower), among other scenic views.

Conveniences of location include parameters such as restaurants nearby, distance from center of town, distance to airport, near mass or public transportation, neighborhood safety, distance from attractions, ambience of hotel, environmental setting of the hotel, and combinations thereof. Attractions may include beaches, theaters, drug stores, convention centers, highways, golf, spa, and parks. The ambience of hotel may refer to the atmosphere of the hotel itself; for example, for those looking for a more romantic setting. The environmental setting of the hotel may refer to whether the hotel is located in a quiet, loud, congested, uncrowded, or busy location.

Hotel characteristics include parameters such as good service, eco-friendly, family-friendly, business-friendly, couple-friendly, pet-friendly, amenities for the disabled, and combinations thereof. Family-friendly hotel may offer optional cribs, recreation area, discounted kids' meals, and onsite babysitting. Amenities for the disabled include being wheelchair accessible, priority parking, automated door opening, mid-height light switches and power outlets, among other amenities.

Hotel services include parameters such as automated check-in, loyalty programs, and combinations thereof.

Amenities include parameters such as gym or Fitness Center, same day laundry, business center, pool, sauna, jacuzzi, on-site restaurant, internet, parking, breakfast included, and combinations thereof. Internet refers to any known internet service, including wireless internet services.

In another embodiment of the present invention, the parameters include nicely furnished rooms, good service, restaurants nearby, distance from center of town, value for money, good sized rooms, automated check-in, gym, same day laundry, and business center.

Another embodiment of the present invention is a non-transitory computer readable medium having computer readable instructions embodied therein, the computer readable instructions being configured to implement a method of reviewing and selecting hotels based upon graded parameters when executed. “Non-transitory computer readable medium” may not include a transitory signal.

FIG. 2 illustrates an embodiment of the present invention. Clients access the hotel review and selection application 201 with an enabled computing device 204. The enabled computing devices 204 may include such devices as tablet computers, smart phones, personal computers, laptop computers, scanners, game consoles and the like. The hotel review and selection application 201 may be software designed to help the clients review and select hotels based on various parameters. The hotel review and selection application 201 may also communicate with the hotel review and selection server 203 through the computer network 202. The computer network 202 may be, for example, the internet.

The hotel review and selection server 203 may contain various modules, including parameter module 207, the client module 208 and the hotel module 209. Each module 207, 208, 209 may store data. For example, the parameter module 207 may store the various parameters that clients may utilize to help the clients review and select hotels. The client module 208 may store information, details, and descriptions of the client's background (name, location, account number, login name, passwords, among other information), and other information. Also, the hotel module 209 may store the hotel's background (name, location, description, grades, among other information), and other information. The hotel review and selection server 203 may contain various other modules not shown, such as, a module that allows the client to post videos and photos related the client's stay at the hotel.

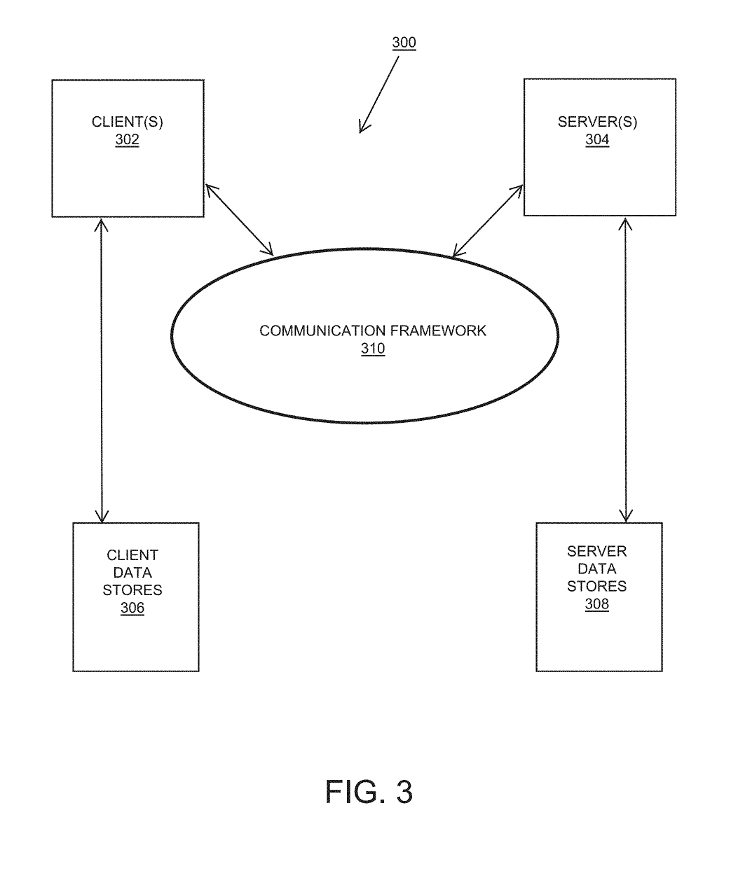

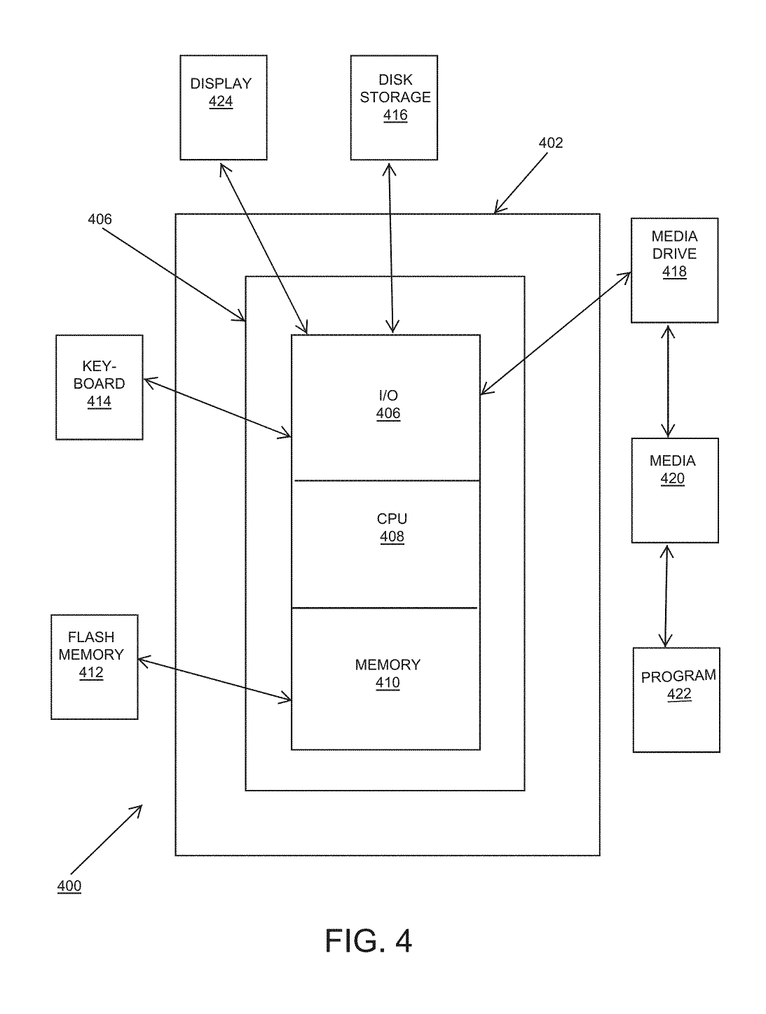

FIGS. 3 and 4 illustrate exemplary computing environments, devices and architectures for the implementation of the various embodiments of the present invention.

FIG. 3 illustrates a sample computing environment 300 that can be utilized in some embodiments. The system 300 further illustrates a system that includes one or more client(s) 302. The client(s) 302 can be hardware and/or software (e.g., threads, processes, computing devices). The system 300 also includes one or more server(s) 304, such as hotel review and selection server 203. The server(s) 304 can also be hardware and/or software (e.g., threads, processes, computing devices). One possible communication between a client 302 and a server 304 may be in the form of a data packet adapted to be transmitted between two or more computer processes. The system 400 includes a communication framework 310 that can be utilized to facilitate communications between the client(s) 302 and the server(s) 304. The client(s) 302 are connected to one or more client data store(s) 306 that can be employed to store information local to the client(s) 302. Similarly, the server(s) 304 are connected to one or more server data store(s) 308 that can be employed to store information local to the server(s) 304.

FIG. 4 depicts an exemplary computing system 400 that can be configured to perform any one of the above-described processes. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform the above-described processes. The main system 402 includes a motherboard 404 having an I/O section 406, one or more central processing units (CPU) 408, and a memory section 410, which may have a flash memory card 412 related to it. The I/O section 406 is connected to a display 424, a keyboard 414, a disk storage unit 416, and a media drive unit 418. The media drive unit 418 can read/write a computer-readable medium 420, which can contain programs 422 and/or data. Although, not shown, in some embodiments, computing system 400 can include an eye-tracking system and/or be coupled with an eye-tracking system.

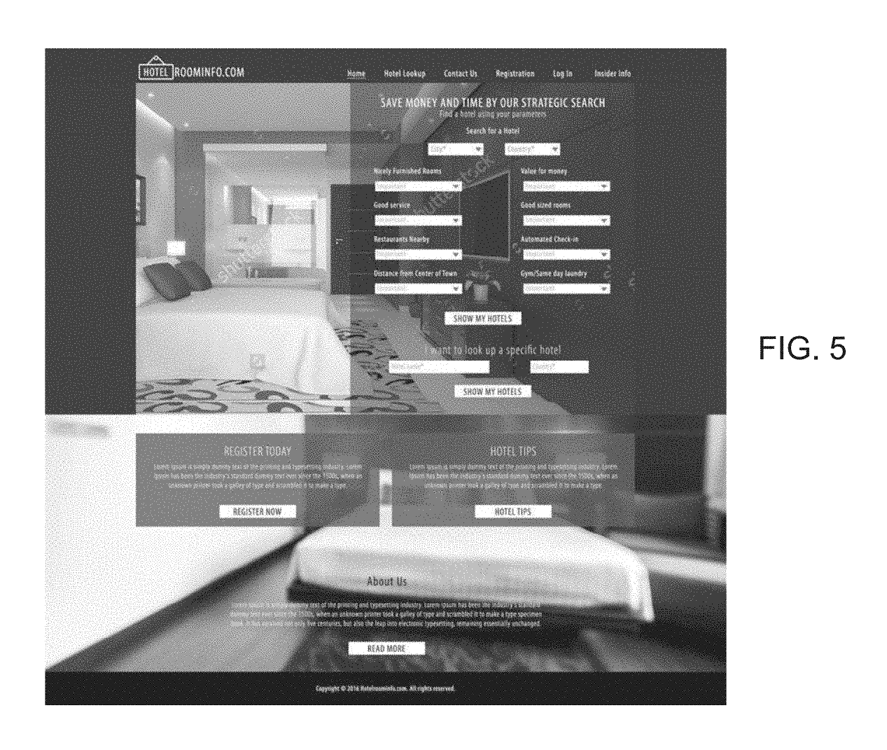

FIGS. 5-7 illustrate screen shots from a graphical user interface for implementations of some of the embodiments of the present invention.

FIG. 5 illustrates a representative example of a search page for client using the hotel review and selection application 201 with an enabled computing device 204. To begin, for example, the client would enter a location, such as city name and country, where the client is interested in finding a hotel. The client may select and rank several parameters; in this example, the parameters include “Nicely Furnished Rooms,” “Good service,” “Restaurants Nearby,” “Distance from Center of Town,” “Value for money,” “Good sized rooms,” Automated Check-in,” and “Gym/Same day laundry.” The client may select as many parameters as the client desires, preferably at least two, but the client may select only one. After choosing parameters in which the client is interested, the client then ranks the parameters from the most important to the least important. Then, the client receives a list of hotels based upon the highest graded hotels for the client's most important parameter. If two hotels have the same grade for the client's most important parameter, then the hotel review and selection application 201 will utilize the next most important parameter (in other words, the parameter that the client ranked as the second most important parameter). The hotel with the higher grade for the second most important parameter would appear higher on the list of hotels resulting from the search. This may be repeated for the third, fourth, fifth, sixth, seventh and eighth most important parameters, if necessary.

As an example, the client may choose to look for a hotel in the city of Toronto in the country of Canada. The client then chooses and ranks the parameters of the client's interest in the following order: “Value for money,” “Restaurants Nearby,” and “Good service.” The ranking of the parameters may be numerically, in this example, as there are eight parameters, the client assigns an eight to the most important parameter (“Value for money”), a seven to the second most parameter (“Restaurants Nearby”), and a six to the third most important parameter (“Good service”). The hotel review and selection application 201 will generate a list of hotels based upon the client's chosen parameters and the grades based on reviews of prior guests. For example, there are four hotels (A, B, C and D) that meet the client's criteria of being in Toronto, Canada. For “Value for money,” “Restaurants Nearby,” and “Good service”: Hotel A has grades of 7, 5, and 1, respectively; Hotel B has grades of 5, 6 and 2, respectively; Hotel C has grades of n/a, 7 and 3, respectively; and, Hotel D has grades of 7, 3 and 2, respectively. The hotels will be listed in the following order: Hotel A, Hotel D, Hotel B, then Hotel C because Hotels A and D have the highest grade (7) for the client's most important parameter, “Value for money.” Because both these hotels have the same grade, then based upon the second most important parameter, “Restaurants Nearby,” Hotel A has higher grade (5) than Hotel D (3), Hotel A is listed ahead of Hotel D. Then, Hotel B is listed next because it has the next highest grade for the client's most important parameter, “Value for money.” Then, Hotel C is listed next because has the lowest grade (in this example, Hotel C has yet to receive a grade for this parameter) the client's most important parameter, “Value for money.” This example is representative and is not meant to be limiting, for example, the hotel review and selection application 201 may utilize more than eight parameters; the client may be interested in more than three parameters; the grades may be represented by other grading systems in that it may is not required to be numeric grades or that the grades are fractions and not whole numbers; and, the resulting list may have more or less than four hotels.

The client may want to suppress or exclude one or more parameters from the search. The client may do so by assigning zero to those parameters. The client may have an unlimited budget and may wish to stay in hotels of the finest refinement only. In such an instance, the client may rank the parameter “Value for money” as zero, so that lower priced hotels are not selected and only the other ranked parameters will be utilized by the hotel review and selection application 201 to determine the grades of the hotels.

Alternatively, the client may know the name of the hotel and location and input that information into the hotel review and selection application 201. Whether the client utilizes the choosing and ranking the parameters or entering the name and location of the hotel, the hotel review and selection application 201 will generate a list of hotels and display information related to the hotel. The information may include the hotel's name, description, location, contact information, grades for each parameter, among other hotel information.

The client may grade a hotel at which the client was a guest. The client may grade every parameter, or just those of interest to the client. The hotel review and selection application 201 will then use the client's grades to calculate and update the parameter grades for future clients of the hotel review and selection application 201.

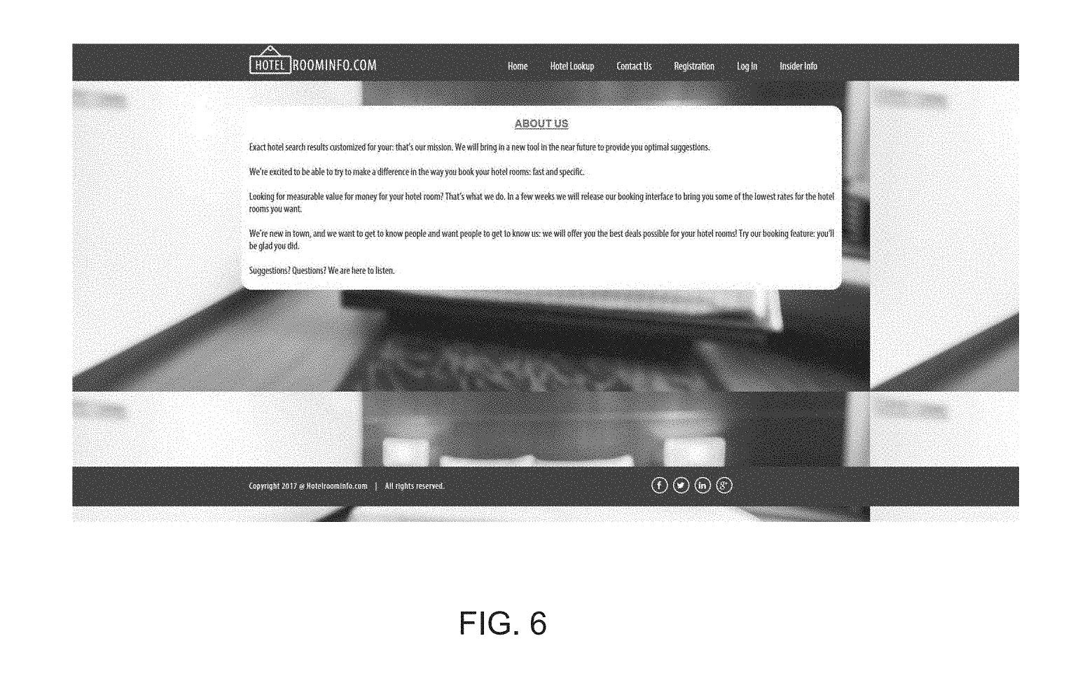

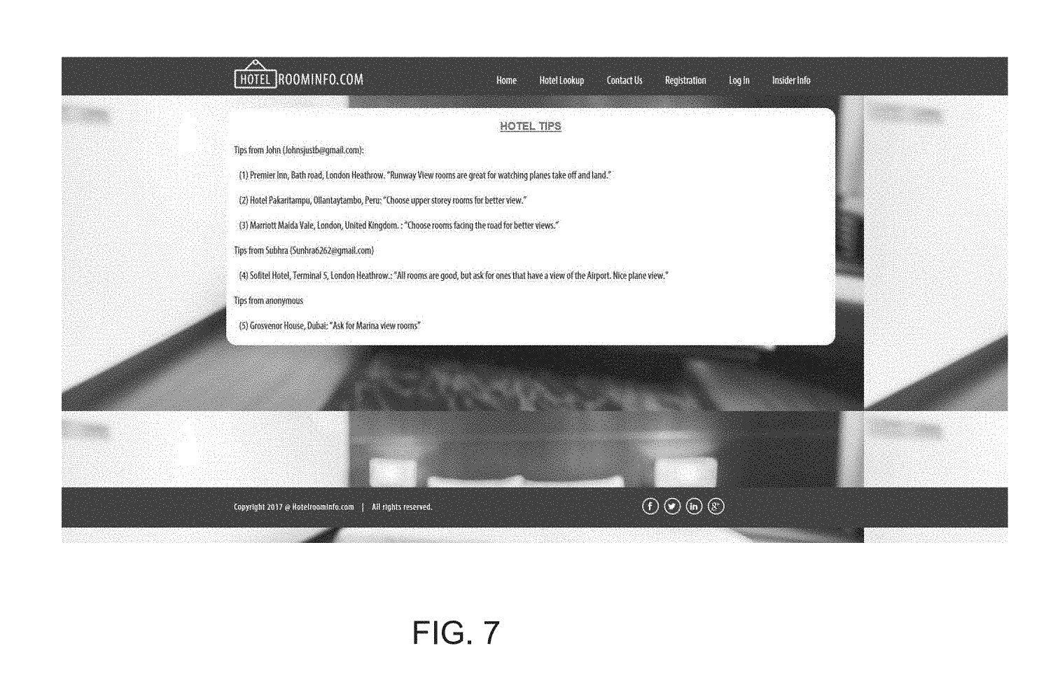

FIG. 6 illustrates a representative example of an “ABOUT US” page for client using the hotel review and selection application 201 with an enabled computing device 204. FIG. 7 illustrates a representative example of an “HOTEL TIPS” page for client using the hotel review and selection application 201 with an enabled computing device 204. These may include tips or advice from previous hotel guests.

I claim:

1. A computer system comprising:
at least one processor unit;
at least one memory unit coupled to the at least one processor unit; and,
computer readable instructions embodied in the memory unit and executable by the processor unit, wherein execution of the instructions by the processor unit causes the computing system to perform a method of reviewing and selecting hotels based upon graded parameters, the method comprising:
storing hotel grades for each of a plurality of hotel parameters based upon reviews of past guest reviews;
providing the plurality of hotel parameters to a client;
receiving rankings of the client for the hotel parameters;
ordering each ranked parameter from most important parameter to least important parameter;
ordering hotels with the hotel grades for the most important parameter from highest graded hotel to lowest graded hotel;
creating a list of hotels from highest graded hotel to lowest graded hotel; wherein if more than one of the hotels have the same hotel grade for the most important parameter, then the hotel with a higher rating for the next most important parameter is the higher graded hotel; and,
displaying the list of hotels to the client.

2. The computer system of claim 1, wherein the method further comprises:
displaying the hotel grades of each parameter for a client-selected hotel from the list of hotels; and,
displaying hotel information for the client-selected hotel.

3. The computer system of claim 2, wherein the method further comprises:
receiving booking information from the client.

4. The computer system of claim 3, wherein the method further comprises:
obtaining client-inputted hotel grades for the client-selected hotel;
obtaining a client-inputted written review for the client-selected hotel;
calculating updated hotel grades for the hotel parameters; and,
storing the updated hotel grades for the hotel parameters.

5. The computer system of claim 4, wherein each of the parameters are selected from the group consisting of room feature, convenience of location, value for money, hotel characteristic, hotel service, amenity, and combinations thereof.

6. The computer system of claim 5,
wherein the room feature is selected from the group consisting of nicely furnished rooms, well appointed bathrooms, views, cleanliness of rooms, kitchen, refrigerator, microwave, and combinations thereof;
wherein the convenience of location is selected from the group consisting of restaurants nearby, distance from center of town, distance to airport, near public transportation, neighborhood safety, distance from attractions, ambience of hotel, environmental setting of the hotel, and combinations thereof;
wherein the hotel characteristic is selected from the group consisting of good service, eco-friendly, family-friendly, business-friendly, couple-friendly, pet-friendly, amenities for the disabled, and combinations thereof;
wherein the hotel service is selected from the group consisting of automated check-in, loyalty programs, and combinations thereof; and,
wherein the amenity is selected from the group consisting of gym, same day laundry, business center, pool, sauna, jacuzzi, on-site restaurant, internet, parking, breakfast included, and combinations thereof.

7. The computer system of claim 6, wherein the parameters are nicely furnished rooms, good service, restaurants nearby, distance from center of town, value for money, good sized rooms, automated check-in, gym, same day laundry, and business center.

8. A method of reviewing and selecting hotels based upon graded parameters, the method comprising:
storing hotel grades for each of a plurality of hotel parameters based upon reviews of past guest reviews;
providing the plurality of hotel parameters to a client;
receiving rankings of the client for the hotel parameters;
ordering each ranked parameter from most important parameter to least important parameter;
ordering hotels with the hotel grades for the most important parameter from highest graded hotel to lowest graded hotel;
creating a list of hotels from highest graded hotel to lowest graded hotel; wherein if more than one of the hotels have the same hotel grade for the most important parameter, then the hotel with a higher rating for the next most important parameter is the higher graded hotel; and,
displaying the list of hotels to the client.

9. The method of claim 8 further comprising:
displaying the hotel grades of each parameter for a client-selected hotel from the list of hotels; and,
displaying hotel information for the client-selected hotel.

10. The method of claim 9 further comprising:
receiving booking information from the client.

11. The method of claim 10 further comprising:
obtaining client-inputted hotel grades for the client-selected hotel;
obtaining a client-inputted written review for the client-selected hotel;
calculating updated hotel grades for the hotel parameters; and,
storing the updated hotel grades for the hotel parameters.

12. The method of claim 11, wherein each of the parameters are selected from the group consisting of room feature, convenience of location, value for money, hotel characteristic, hotel service, amenity, and combinations thereof.

13. The method of claim 12,
wherein the room feature is selected from the group consisting of nicely furnished rooms, well appointed bathrooms, views, cleanliness of rooms, kitchen, refrigerator, microwave, and combinations thereof;
wherein the convenience of location is selected from the group consisting of restaurants nearby, distance from center of town, distance to airport, near public transportation, neighborhood safety, distance from attractions, ambience of hotel, environmental setting of the hotel, and combinations thereof;
wherein the hotel characteristic is selected from the group consisting of good service, eco-friendly, family-friendly, business-friendly, couple-friendly, pet-friendly, amenities for the disabled, and combinations thereof;
wherein the hotel service is selected from the group consisting of automated check-in, loyalty programs, and combinations thereof; and,
wherein the amenity is selected from the group consisting of gym, same day laundry, business center, pool, sauna, jacuzzi, on-site restaurant, internet, parking, breakfast included, and combinations thereof.

14. The method of claim 13, wherein the parameters are nicely furnished rooms, good service, restaurants nearby, distance from center of town, value for money, good sized rooms, automated check-in, gym, same day laundry, and business center.

15. A non-transitory computer readable medium having computer readable instructions embodied therein, the computer readable instructions being configured to implement a method of reviewing and selecting hotels based upon graded parameters when executed, the method comprising:
storing hotel grades for each of a plurality of hotel parameters based upon reviews of past guest reviews;
providing the plurality of hotel parameters to a client;
receiving rankings of the client for the hotel parameters;
ordering each ranked parameter from most important parameter to least important parameter;
ordering hotels with the hotel grades for the most important parameter from highest graded hotel to lowest graded hotel;
creating a list of hotels from highest graded hotel to lowest graded hotel; wherein if more than one of the hotels have the same hotel grade for the most important parameter, then the hotel with a higher rating for the next most important parameter is the higher graded hotel; and,
displaying the list of hotels to the client.

16. The non-transitory computer readable medium of claim 15, wherein the method further comprises:
displaying the hotel grades of each parameter for a client-selected hotel from the list of hotels; and,
displaying hotel information for the client-selected hotel.

17. The non-transitory computer readable medium of claim 16, wherein the method further comprises:
receiving booking information from the client.

18. The non-transitory computer readable medium of claim 17, wherein the method further comprises:
obtaining client-inputted hotel grades for the client-selected hotel;
obtaining a client-inputted written review for the client-selected hotel;
calculating updated hotel grades for the hotel parameters; and,
storing the updated hotel grades for the hotel parameters.

19. The non-transitory computer readable medium of claim 18, wherein each of the parameters are selected from the group consisting of room feature, convenience of location, value for money, hotel characteristic, hotel service, amenity, and combinations thereof.

20. The non-transitory computer readable medium of claim 19,
wherein the room feature is selected from the group consisting of nicely furnished rooms, well appointed bathrooms, views, cleanliness of rooms, kitchen, refrigerator, microwave, and combinations thereof;
wherein the convenience of location is selected from the group consisting of restaurants nearby, distance from center of town, distance to airport, near public transportation, neighborhood safety, distance from attractions, ambience of hotel, environmental setting of the hotel, and combinations thereof;
wherein the hotel characteristic is selected from the group consisting of good service, eco-friendly, family-friendly, business-friendly, couple-friendly, pet-friendly, amenities for the disabled, and combinations thereof;
wherein the hotel service is selected from the group consisting of automated check-in, loyalty programs, and combinations thereof; and,
wherein the amenity is selected from the group consisting of gym, same day laundry, business center, pool, sauna, jacuzzi, on-site restaurant, internet, parking, breakfast included, and combinations thereof.

21. The non-transitory computer readable medium of claim 20, wherein the parameters are nicely furnished rooms, good service, restaurants nearby, distance from center of town, value for money, good sized rooms, automated check-in, gym, same day laundry, and business center.
